(19) United States
(12) Patent Application Publication
(10) Pub. No.: US 2009/0068442 A1
(43) Pub. Date: Mar. 12, 2009

(54) GLOSSY INK-JET RECORDING SHEET

(75) Inventors: Hideo Mitsui, Kawasaki-shi (JP); Shinichi Asano, Yokohama-shi (JP); Nobuhisa Dano, Chiba-shi (JP); Yasutaka Koukata, Amagasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: OJI PAPER CO., LTD., Tokyo (JP)

(21) Appl. No.: 11/814,064

(22) PCT Filed: Jan. 18, 2006
(86) PCT No.: PCT/JP2006/300604

§ 371 Date: Aug. 25, 2008

(30) Foreign Application Priority Data
Jan. 18, 2005 (JP) 2005-009836

(51) Int. Cl. B32B 5/16; B32B 27/10

(52) U.S. Cl. 428/331; 428/511; 428/323

(57) ABSTRACT

The present invention provides a glossy ink-jet recording sheet comprising: a paper support; a solvent-absorbing layer comprising a pigment and an adhesive; and an ink-fixing layer comprising a pigment and an adhesive, the ink-fixing layer having a mirror-finished surface; or a glossy ink-jet recording sheet comprising: a paper support; a solvent-absorbing layer comprising a pigment and an adhesive; an ink-fixing layer comprising a pigment and an adhesive; and a glossy layer having a mirror-finished surface; characterized in that the adhesive of the solvent-absorbing layer comprises a ternary copolymer consisting of an alkyl(meth)acrylate, a N-methylolacrylamide, and a styrene.

### TECHNICAL FIELD

The present invention relates to a glossy ink-jet recording sheet with an excellent recording suitability for both dye ink and pigment ink.

Priority is claimed on Japanese Patent Application No. 2005-009836, filed Jan. 18, 2005, the content of which is incorporated herein by reference.

### BACKGROUND ART

A recording system using an ink-jet printer has been used in many fields, due to its low noise, possibility of performing high-speed recording, and ease of producing multicolor images. As an ink-jet recording sheet, a high-quality paper which is designed to be rich in ink absorbing capability, a coated paper in which a porous pigment is coated on the surface thereof, or the like is adopted. However, most of these recording sheets are mat-type ink-jet recording sheets of which the surface glossiness is low. Accordingly, an ink-jet recording sheet having a high surface glossiness and excellent appearance has been demanded.

As an ink-jet recording sheet with a surface glossiness, an ink-jet recording sheet prepared by a casting method which has been adopted for producing print sheets has been proposed. For example, it has been proposed that an ink-jet recording cast-coated paper with excellent glossiness and excellent ink absorbing capability be produced by forming a recording layer including a pigment and an adhesive as the main components thereof on a base paper, followed by forming a cast coating layer thereon by applying a coating liquid mainly containing a copolymer with a glass-transition point of 40° C. or higher, the copolymer being produced by polymerizing monomers having an ethylenically unsaturated bond, and then, while the cast coating layer is in a wet state, bringing the cast coating layer into press contact with a heated mirror-finished drum, and then drying (see, for example, Patent Document 1).

In recent years, improvement of ink absorbing capability has been required so as to meet rapid spread, enhanced detail, and speedup of a printer, and realization of image uniformity equivalent to that of silver-halide photography has also been required so as to meet an appearance of a digital camera. Moreover, further improvement of image recording density and glossiness are required so as to bring the quality of recorded images closer to that of silver-halide photography.

On the other hand, improvement of ink has also been proposed so as to realize image preservability equivalent to that of silver halide photography, and ink in which a hydrophobic coloring pigment with an excellent water resistance and excellent light resistance is dispersed (hereinafter, referred to as a “pigment ink”) has been often used as well as an aqueous dye ink containing a highly-hydrophilic coloring agent conventionally used mainly (hereinafter, referred to as a “dye ink”).

The coloring pigment in the pigment ink tends to stay on the surface of a coating layer of an ink-jet recording sheet when recording is performed, and the pigment ink exhibits a lack of fixability and scratch resistance on a highly-gloss ink-jet recording sheet which is designed to be suitable for the conventionally provided dye ink. Accordingly, recording media in which printing can be performed with high quality using dye ink and pigment ink have been strongly required.

In order to realize the above, various proposals have been made to realize an even higher ink-absorbing rate and even higher glossiness while preventing cracking of a coating film of a coating layer and realizing round dots using a fine pigment with an average particle diameter of approximately 0.1 μm or less in the coating layer.

For example, Patent Document 2 discloses that colloidal silica is formulated in an ink-receiving layer and the peak in the pore diameter distribution curve of an ink-receiving layer is adjusted to 100 nm (0.1 μm) or less so as to improve glossiness and uniformity of image density. However, in the case where a high-quality image is printed using a large amount of ink, the ink is not sufficiently absorbed. Also, if the coating amount is increased so as to increase ink absorbing capability, there is a case in which cracking occurs when coating is performed.

In the same way, Patent Document 3 discloses an ink-jet recording material containing a fine pigment with an average particle diameter of 0.1 μm or less and PVA with a high polymerization degree, the ink-jet recording material preventing cracking of a coating film. Although the ink-jet recording material realizes high glossiness and high image density, and excellent uniformity, the ink-absorbing rate thereof is not sufficient, because the speedup of printers has significantly increased.

Moreover, Patent Document 4 discloses that a hardener that cross-links with an adhesive in a coating film is formulated so as to realize high ink absorbing capability. However, the ink-absorbing rate remains insufficient, since pigments in all coating layers are of the submicron order. Also, high cost is required, since pigments in all ink-receiving layers are of the submicron order.

Moreover, Patent Document 5 discloses that at least two ink-jet recording layers containing agglomerated fine particles with an average secondary particle diameter of 1 μm or less and an adhesive are formed on a paper support, followed by subjecting the outermost surface of the ink-jet recording layers to a mirrored-finish so as to simultaneously improve image density, glossiness, ink absorbing capability, and the like. However, there is a case in which cracking occurs in the coating film depending on conditions, and an obtained ink-jet recording material exhibits a lack of roundness of dots and deteriorated image uniformity.

Patent Document 1: Japanese Patent Application, First Publication No. H 7-89220.
Patent Document 2: Japanese Patent Application, First Publication No. H 9-183267.
Patent Document 3: Japanese Patent Application, First Publication No. H7-117334.
Patent Document 4: Japanese Patent Application, First Publication No. H10-119423.

Patent Document 5: Japanese Laid-Open Patent Application, No. 2001-10220.

### DISCLOSURE OF THE INVENTION

### Problems to be Solved by the Invention

An object of the present invention is to solve the above-mentioned problems, and to provide an ink-jet recording sheet which exhibits such favorable ink absorbing capability that high-speed recording can be realized, the ink-jet recording sheet also producing round dots and images with excellent uniformity.

A particular object of the present invention is to provide an ink-jet recording sheet having a favorable coating film strength, favorable glossiness, and an ability to provide high image density, and being suitable for both dye and pigment ink.

### Means for Solving the Problems

As a result of accumulated investigation carried out so as to achieve the above-mentioned object, the inventors of the present invention have found that the object is achieved by adopting the following constitutions, and then completed the present invention.

[1] A glossy ink-jet recording sheet containing: a paper support; a solvent-absorbing layer containing a pigment and an adhesive; and an ink-fixing layer containing a pigment and an adhesive, the ink-fixing layer having a mirror-finished surface; characterized in that the adhesive of the solvent-absorbing layer contains a ternary copolymer consisting of an alkyl(meth)acrylate, a N-methylolacrylamide, and a styrene.
[2] A glossy ink-jet recording sheet containing: a paper support; a solvent-absorbing layer containing a pigment and an adhesive; an ink-fixing layer containing a pigment and an adhesive; and a glossy layer having a mirror-finished surface; characterized in that the adhesive of the solvent-absorbing layer contains a ternary copolymer consisting of an alkyl(meth)acrylate, a N-methylolacrylamide, and a styrene.

The present invention contains the following aspects.

[3] A glossy ink-jet recording sheet set forth in [1] or [2], in which the pigment of the solvent-absorbing layer has an average particle diameter of 1 μm or more and 20 μm or less.
[4] A glossy ink-jet recording sheet set forth in any one of [1] to [3], in which the pigment of the ink-fixing layer is at least one selected from the group consisting of a silica, an aluminosilicate, and an alumina, the silica, the aluminosilicate, and the alumina being a secondary particle having an average primary particle diameter of 0.003 μm or more and 0.04 μm or less, and an average secondary particle diameter of 0.01 μm or more and 0.7 μm or less; and the adhesive of the ink-fixing layer mainly contains a polyvinyl alcohol.
[5] A glossy ink-jet recording sheet set forth in [4], in which the ink-fixing layer further contains a compound having a cross-linkability with the polyvinyl alcohol.
[6] A glossy ink-jet recording sheet set forth in any one of [1] to [5], in which the paper support contains a chlorine-free pulp.

### EFFECTS OF THE INVENTION

The ink-jet recording sheet according to the present invention exhibits such favorable ink absorbing capability that high-speed recording can be realized, and also produces round dots and images with excellent uniformity. In particular, the ink-jet recording sheet has a favorable coating film strength and favorable glossiness, and can provide high image density, and thus the ink-jet recording sheet is suitable for both dye and pigment ink.

### BEST MODE FOR CARRYING OUT THE INVENTION

### Layer Constitution

The present invention relates to a glossy ink-jet recording sheet having a constitution in which a solvent-absorbing layer and an ink-fixing layer are laminated essentially in this order on one surface of a paper support, and the ink-fixing layer is mirror-finished (first aspect), and a glossy ink-jet recording sheet having a constitution in which a solvent-absorbing layer, an ink-fixing layer, and a glossy layer are laminated essentially in this order on one surface of a paper support, and the glossy layer is mirror-finished (second aspect). Although the solvent-absorbing layer is a layer that mainly absorbs a solvent contained in ink, the ink-fixing layer is a layer that mainly fixes a coloring agent contained in ink, that is, a dye or a coloring pigment, and the glossy layer is a layer that mainly enhances glossiness, other functions may be imparted on these layers. Each of the solvent-absorbing layer, the ink-fixing layer, and the glossy layer may be formed in plural layers.

### “Paper Support”

A paper support is not particularly limited, provided that the paper support has air-permeability. As the paper support, acid paper, acid-free paper, or other paper generally used to produce coated paper or the like is suitably used. As wood pulp composing the paper support, chemical pulp such as kraft pulp (KP), sulfite pulp (SP), soda pulp, or the like, semichemical pulp such as semichemical pulp (SCP), chemigroundwood pulp (CGP) or the like, mechanical pulp such as ground pulp (GP), thermomechanical pulp (TMP, BCTMP), refiner ground wood pulp (RGP), or the like, non-wood pulp composed of hemp, kenaf, or the like, or deinked pulp composed of wastepaper may be used. It is preferable that pulp bleached by combinatorially using chlorine, chlorine dioxide, oxygen, ozone, hydrogen peroxide, hypochlorous acid, or the like be used to enhance whiteness thereof. Among these, chlorine-free pulp, such as ECF-bleached one, TCf-bleached one, or the like is preferably used, because the produced recording sheet is hardly yellowed even if it is stored for a long time. These pulps may be used alone or in combination of at least two kinds thereof.

The beating degree of the pulp may be adjusted using a beater so as to adjust paper strength, paper making suitability, or the like. Although the beating degree (freeness) of the pulp is not particularly limited, the beating degree is generally approximately within the range of 250 to 550 ml (CSF: JIS-P-8121). It is preferable that the beating degree be high so as to improve smoothness. However, the pulp with a low beating degree often favorably prevents occurrence of roughness of the sheet and bleeding of recorded images, the roughness and bleeding being caused by the moisture content in ink, when recording is performed on a produced recording sheet. Accordingly, it is preferable that the freeness be approximately within the range of 300 to 500 ml.

In the paper support, an auxiliary such as a sizing agent, fixing agent, paper strength improver, cationizing agent, yield improver, dye, fluorescent brightener, or the like, may be formulated at the time of paper-making. Moreover, starches, polyvinyl alcohols, cationic resins, or the like, may be applied or penetrated at the time of size-pressing using a paper-making apparatus, so as to adjust the surface strength, size, or the like. The Stoeckigt sizing degree (of 100 g/m² paper) is preferably within the range of 1 to 200 seconds. When the Stoeckigt sizing degree is low, there is a case in which operation is affected by generating wrinkles during coating. When the Stoeckigt sizing degree is high, there is a case in which ink absorbing capability deteriorates, or curling or cockling significantly occurs after printing. The Stoeckigt sizing degree is more preferably within the range of 4 to 120 seconds. Although the basis weight of the paper support is not particularly limited, the basis weight is generally approximately within the range of 20 to 400 g/m², and preferably 100 to 350 g/m². When the basis weight is extremely low, there is a tendency in which curling or cockling significantly occurs when ink-jet printing is performed, or the opacity is hardly realized. When the basis weight is high, the glossiness tends to deteriorate.

The paper support with air-permeability can be used. It is preferable that the air-permeability according to the Ohken method be approximately within the range of 10 to 200 seconds/100 cc, more preferably 10 to 150 seconds/100 cc, and even more preferably 10 to 100 seconds/100 cc. When the air-permeability is extremely high, the glossiness tends to deteriorate. The reason for this is assumed to be that extremely high air-permeability causes insufficient drying or excessive heating, when the outermost layer (the ink-fixing layer or the glossy layer) is dried using a mirror-finished drum to vaporize the moisture content of a coating liquid through the paper support, as a result of which the glossiness deteriorates Moreover, when the air-permeability is further increased, operationality at the time of cast-finishing deteriorates. On the other hand, when the air-permeability of the paper support is below 10 seconds/100 cc, the glossiness also tends to deteriorate. The reason for this is assumed to be that most of an adhesive contained in a coating liquid penetrates into the paper support during forming an ink-jet recording layer, and thereby the adhesive content in an ink-jet recording layer decreases, as a result of which glossiness deteriorates.

The paper-making apparatus is not particularly limited, and various well-known paper-making apparatuses such as a known Fourdrinier-type paper-making apparatus, cylindrical paper-making apparatus, Yankee-type paper-making apparatus, twin wire former, inclined wire former, or the like, or a drier such as Yankee-type drier, multi-cylinder type drier, or the like, may be used. Various known treatments such as calendering treatment may be performed.

### “Solvent-Absorbing Layer”

The solvent-absorbing layer according to the present invention is formed on the paper support so as to increase ink-absorbing capacity and ink-absorbing rate. The solvent-absorbing layer contains a pigment and an adhesive, particularly a ternary copolymer particularly composed of alkyl(meth)acrylate, N-methylolacrylamide, and styrene. The ink-fixing layer is a layer which mainly fixes a coloring agent contained in ink, such as a dye or coloring pigment, while the solvent-absorbing layer is a layer which mainly absorbs a solvent contained in ink rapidly. However, there is no significant distinction between the ink-fixing layer and the solvent-absorbing layer. When the ink amount is small, the coloring agent may be absorbed merely in the ink-fixing layer. However, when the ink amount is large, a portion of the coloring agent may be fixed in the solvent-absorbing layer. Moreover, the solvent-absorbing layer may be formed to increase the opacity.

The solvent-absorbing layer contains a pigment and an adhesive as its main components.

As the pigment contained in the solvent-absorbing layer, at least one of various pigments well known to be conventionally used to manufacture general coated sheets, such as kaolin, clay, sintered clay, noncrystalline silica (alternatively, referred to as amorphous silica), synthetic noncrystalline silica, zinc oxide, aluminium oxide, aluminium hydroxide, calcium carbonate, satin white, aluminum silicate, alumina, colloidal silica, zeolite, synthetic zeolite, sepiolite, smectite, synthetic smectite, magnesium silicate, magnesium carbonate, magnesium oxide, diatomaceous earth, styrene-based plastic pigment, hydrotalcite, urea resin-based plastic pigment, benzoguanamine-based plastic pigment, or the like, may be used. Among these, amorphous silica, alumina, and zeolite realize high ink absorbing capability, and thus are preferably formulated as the main component.

It is preferable that the pigment (formulated as the main component) have an average particle diameter (average agglomerated particle diameter in the case of an agglomerated pigment) of approximately within the range of 1 μm or more and 20 μm or less, more preferably 2 μm or more and 15 μm or less, and even more preferably 3 μm or more and 10 μm or less. When the average particle diameter is less than 1 μm, there is a possibility in which the ink-absorbing rate is not sufficiently increased. When the average particle diameter is greater than 20 μm, there is a possibility in which the smoothness or glossiness is not sufficiently exhibited after forming the ink-fixing layer or the glossy layer. However, a pigment with a small particle diameter may be formulated as an accessory ingredient so as to adjust the ink absorbing capability, or to control impregnation of coating materials applied on the solvent-absorbing layer. As such a pigment, a colloidal silica, alumina sol, silica fine particles which are the same as those formulated in the ink-fixing layer, or the like, may be used.

According to the present invention, the solvent-absorbing layer contains as the adhesive a ternary copolymer composed of alkyl(meth)acrylate, N-methylolacrylamide, and styrene.

Examples of alkyl(meth)acrylate include methyl (meth)acrylate, ethyl (meth)acrylate, n-propyl (meth)acrylate, iso-proply (meth)acrylate, n-butyl (meth)acrylate, iso-butyl (meth)acrylate, tert-butyl (meth)acrylate, n-amyl (meth)acrylate, iso-amyl (meth)acrylate, hexyl (meth)acrylate, 2-ethylhexyl (meth)acrylate, octyl (meth)acrylate, iso-nonyl (meth)acrylate, decyl (meth)acrylate, dodecyl (meth)acrylate, tridecyl (meth)acrylate, stearyl (meth)acrylate, and the like, and these may be used singularly or in combination of two or more. Among these, from the viewpoint of production stability, one having an alkyl group including 1 to 12 carbon atoms is particularly preferable.

The glass transition temperature of the ternary copolymer is preferably within the range of −80 to +50° C., and more preferably −50 to +30° C. When the glass transition temperature is less than −80° C., the ink absorbing capability tends to deteriorate. When the glass transition temperature is more than +50° C., the cracking strength of the coating layer tends to decrease.

The amount of alkyl(meth)acrylate is preferably 5 to 90 parts by mass with respect to 100 parts by mass of the ternary copolymer. The amount of N-methylolacrylamide is preferably 5 to 90 parts by mass with respect to 100 parts by mass of the ternary copolymer. The amount of styrene is preferably 5 to 90 parts by mass with respect to 100 parts by mass of the ternary copolymer. If the amount of alkyl (meth)acrylate is less than 5 parts by mass, the cracking strength of the coating layer tends to decrease, as a result of which cracking of the coating layer may easily occur. If the amount of alkyl(meth)acrylate is more than 90 parts by mass, deterioration of the ink absorbing capability and generation of image unevenness tend to be easily caused. If the amount of N-methylolacrylamide is less than 5 parts by mass, deterioration of the ink absorbing capability and generation of image unevenness tend to be easily caused. If the amount of N-methylolacrylamide is more than 90 parts by mass, the cracking strength of the coating layer tends to deteriorate, as a result of which cracking of the coating layer or loss of powder from the surface of the coating layer may easily occur. If the amount of styrene is less than 5 parts by mass, the frictional strength tends to decrease, as a result of which loss of powder from the surface of the coating layer may easily occur. If the amount of styrene is more than 90 parts by mass, deterioration of the ink absorbing capability and generation of image unevenness tend to be easily caused. The ternary copolymer may be a block copolymer or a random copolymer.

The amount of the ternary copolymer composed of alkyl(meth)acrylate, N-methylolacrylamide, and styrene is preferably 5 to 50 parts by mass, more preferably 10 to 30 parts by mass, with respect to 100 parts by mass of the pigment. If the amount of the ternary copolymer is less than 5 parts by mass, the surface strength of the coating layer tends to decrease, as a result of which the loss of powder from the surface of the coating layer and cracking of the coating layer tend to easily occur. If the amount of the ternary copolymer is more than 50 parts by mass, deterioration of the ink absorbing capability and generation of image unevenness tend to be easily caused.

The solvent-absorbing layer may further contain known adhesives in addition to the ternary copolymer composed of alkyl(meth)acrylate, N-methylolacrylamide, and styrene. As the adhesives to be used in combination, conventionally known adhesives which are generally used to produce coated paper may be used, and examples thereof include proteins such as, for example, casein, soy bean protein, and synthetic protein; various starches, such as, for example, ordinary starch and oxidized starch; polyvinyl alcohols such as polyvinyl alcohol and modified polyvinyl alcohols such as, for example, polyvinyl alcohol, cationized polyvinyl alcohol, and silyl-modified polyvinyl alcohol; cellulose derivatives, such as, for example, carboxymethyl cellulose and methyl cellulose; conjugated diene polymer latexes such as, for example, styrene-butadiene copolymer and methyl methacrylate-butadiene copolymer; acryl polymer latexes; and vinyl copolymers, such as, for example, ethylene-vinyl acetate copolymer. Among them, it is particularly preferable that polyvinyl alcohols be used together the ternary copolymer composed of alkyl(meth)acrylate, N-methylolacrylamide, and styrene, in that the coating strength can be enhanced while maintaining the ink-absorbing capacity and the ink-absorbing rate. Moreover, the existence of the ternary copolymer composed of alkyl(meth)acrylate, N-methylolacrylamide, and styrene, in the solvent-absorbing layer prevents deterioration of coating film strength, the deterioration generally being caused by a cross-linking agent contained in the ink-fixing layer, the existence of the ternary copolymer being preferable in terms of stability of the coating liquid.

When the ternary copolymer composed of alkyl(meth)acrylate, N-methylolacrylamide, and styrene is used together with the other adhesives, it is preferable that the amount of the ternary copolymer be within the range of 10 to 160 parts by mass, and more preferably 20 to 120 parts by mass, with respect to 100 parts by mass of the other adhesives. If the ternary copolymer is formulated in such a preferable amount within the above-mentioned range, the coating film strength can be enhanced while maintaining ink-absorbing capacity and ink-absorbing rate.

The content ratio of the adhesive with respect to 100 parts by mass of the pigment in the solvent-absorbing layer, although this depends on the kind thereof, is adjusted to generally within the range of 1 to 100 parts by mass, and preferably 2 to 70 parts by mass. In addition to the above, various auxiliaries used to manufacture general coated paper, such as, for example, dispersants, thickeners, antifoamers, antistats, or antiseptics may be suitably formulated. In the solvent-absorbing layer, a fluorescent dye, or a coloring agent may be formulated.

In the solvent-absorbing layer, a cationic compound may be formulated so as to fix a coloring agent (dye or coloring pigment) component contained in ink. As the cationic compound, cationic compounds exemplified as those to be formulated in the ink-fixing layer are suitably used. However, the amount of the cationic compound in the solvent-absorbing layer is 50% or less, and preferably 20% or less, with respect to that of the cationic compound in the ink-fixing layer, because high recording density and clear images can be realized by fixing ink in the ink-fixing layer, in comparison with the case where ink is fixed in the solvent-absorbing layer. Moreover, it is preferable that the cationic compound be formulated merely in the ink-fixing layer, and be substantially not formulated in the solvent-absorbing layer. The phrase “be substantially not formulated” excepts the case where a slight amount of cationic surfactant or the like is formulated as an auxiliary component.

A coating liquid for the solvent-absorbing layer is generally adjusted so that the solid content thereof is approximately within the range of 5 to 50% by mass, and is generally applied on the paper support in a dry mass of 2 to 100 g/m² preferably approximately 5 to 50 g/m², and even more preferably approximately 5 to 20 g/m². If the coating amount is extremely small, there is a possibility in which the ink absorbing capability is not sufficiently improved, and glossiness of the mirror-finished ink-fixing layer or glossy layer is not sufficiently provided. If the coating amount is extremely large, there is a case in which the print density decreases, or the strength of the coating layer decreases to cause loss of powder or easily generate scratches.

The solvent-absorbing layer is formed by applying and drying the coating liquid for the solvent-absorbing layer using various known coating apparatuses such as a blade coater, an air knife coater, a roll coater, brush coater, champflex coater, bar coater, lip coater, gravure coater, curtain coater, slot die coater, slide coater, or the like. The coating step may be performed two or more times. Moreover, a smoothing treatment such as, for example, supercalendering, or brushing, may be performed, as needed, after the solvent-absorbing layer is dried.

### “Ink-Fixing Layer”

The ink-fixing layer contains a pigment and an adhesive as its main components, and may further contain a cationic compound, as needed. As the pigment of the ink-fixing layer, at least one selected from kaolin, clay, sintered clay, silica, zinc oxide, aluminium oxide, aluminium hydroxide, calcium carbonate, satin white, aluminum silicate, alumina, colloidal silica, zeolite, synthetic zeolite, sepiolite, smectite, synthetic smectite, magnesium silicate, magnesium carbonate, magnesium oxide, diatomaceous earth, styrene-based plastic pigment, hydrotalcite, urea resin-based plastic pigment, benzoguanamine-based plastic pigment, and the like, may be used alone or in combination thereof.

Among them, a fine pigment with an average secondary particle diameter of 0.01 μm or more and 0.7 μm or less is preferably used. If the average secondary particle diameter is 0.7 μm or less, it is possible to prevent a tendency in which the desired print density is not realized because the transparency of the ink-fixing layer decreases and the color developability of the coloring agent fixed in the ink-fixing layer decreases, when ink-jet recording is performed. When the average secondary particle diameter is 0.01 μm or more, it is possible to prevent a tendency in which the desired image quality is not realized because the ink absorbing capability deteriorates and bleeding or the like occurs.

It is preferable that the average particle diameter of primary particles composing the fine pigment be 0.003 μm or more and 0.04 μm or less, more preferably 0.005 μm or more and 0.03 μm or less, and even more preferably 0.007 μm or more and 0.02 μm or less. If the average primary particle diameter is 0.003 μm or more, it is possible to prevent a tendency in which the desired image quality is not realized because the spaces between the primary particles are so small that the ability of absorbing a solvent and coloring agent contained in ink deteriorates. On the other hand, if the average primary particle diameter is 0.04 μm or less, it is possible to prevent a tendency in which the desired print density is not realized because agglomerated secondary particles are so great that the transparency of the ink-fixing layer deteriorates and the color developability of the coloring agent fixed in the ink-fixing layer when the ink-jet recording is performed deteriorates.

The pigment with an average secondary particle diameter of 0.7 μm or less may be obtained by applying a strong force using a mechanical apparatus in accordance with a so-called breaking down method (in which agglomerated raw materials are broken into fine parts). Examples of the mechanical apparatus include an ultrasonic homogenizer, pressure-type homogenizer, liquid-liquid collision type homogenizer, rapidly-rotating mill, roller mill, container driven medium mill, medium stirring mill, jet mill, mortar, disintegrator (apparatus used to grind and knead an object in a bowl-shaped container using a pestle-shaped stirring bar), sand grinder, and the like. In order to decrease the particle diameter, classification and pulverization can be repeatedly conducted.

In the present specification, the phrase “average particle diameter” refers to an average primary particle diameter in the case where primary particles are monodispersed, but refers to an average secondary particle diameter in the case where primary particles are agglomerated to form secondary particles. The average particle diameter (average primary particle diameter or average secondary particle diameter) is determined, regardless of the form (such as powder or slurry) of the pigment, by preparing 200 g of an aqueous dispersion containing 3% of the pigment, stirring and dispersing the dispersion using a commercially available homomixer at 1000 rpm for 30 minutes, and then immediately observing the dispersion using electron microscopes (SEM and TEM), (taking an electron micrograph at 10,000 to 400,000-fold magnification, measuring the Martin's diameter of particles within a 5-cm square, and averaging obtained values, see “Fine particle handbook”, Asakura Shoten, page 52, 1991).

As the fine pigment, at least one selected from silica, alumina oxide, and alumina hydrate is preferably used, and silica is more preferably used. As the silica, fumed silica, mesoporous silica, and colloidal matters of wet silica prepared by condensing active silica are preferable. Among them, fumed silica is preferably selected.

The content ratio of the fine particles such as silica with respect to the whole pigment contained in the ink-fixing layer is preferably 50% or more so as to maintain the transparency of the ink-fixing layer. If the content ratio of the fine pigment such as silica fine particles in the whole pigment is less than 50%, there is a possibility in which the transparency deteriorates, and there is a case in which the image quality such as print density or the like deteriorates.

Examples of the adhesive contained in the ink-fixing layer include water-soluble resins (such as, for example, polyvinyl alcohols such as polyvinyl alcohol, cationized polyvinyl alcohols, silyl-modified polyvinyl alcohols, and other modified polyvinyl alcohols, casein, soybean protein, synthetic proteins, starches, carboxyl methyl cellulose, methyl cellulose, and other cellulose derivatives), water-dispersible resins such as, for example, styrene-butadiene copolymers, methyl methacrylate-butadiene copolymers, other conjugated diene copolymer latexes, styrene-vinyl acetate copolymer, and other vinyl-based copolymer latexes, aqueous acrylic resins, aqueous polyurethane resins, aqueous polyester resins, temperature-sensitive polymers, and other known various adhesives used to produce general coated paper, and these may be used alone or in combination thereof. The aqueous polyurethane resin is also generally referred to as an urethane emulsion, urethane latex, polyurethane latex, or the like. The polyurethane resin is obtained by reacting a polyisocyanate compound with a compound containing an active hydrogen. The polyurethane resin is a polymer compound having a relatively large number of urethane bonds and urea bonds. Also, temperature-sensitive polymer compounds described below may be used. Among these, it is preferable that polyvinyl alcohol be contained as the main component due to its adhesiveness to the pigment.

In the case where a cationic compound is formulated in the ink-fixing layer, it is preferable that the adhesive be cationic or nonionic because the stability of a coating liquid is favorable. The amount of the adhesive with respect to 100 parts by mass of the pigment is adjusted to be within the range of 1 to 200 parts by mass, and more preferably 5 to 100 parts by mass. If the amount of the adhesive is excessively small, there is a case in which the strength of the coating layer decreases, the surface of the glossy layer formed thereon is easily scratched, or the loss of powder occurs. On the other hand, if the amount of the adhesive is excessively large, there is a case in which the ink absorbing capability deteriorates and the desired ink-jet recording suitability is not realized.

### (Cationic Compound)

In the ink-fixing layer, a cationic compound may be further formulated, as needed, so as to fix coloring agent (dye or coloring pigment) components contained in ink for ink-jet recording.

As the cationic compound, well-known cationic compounds may be used. Examples thereof include: 1) polyalkylene polyamines such as polyethylene polyamine or polypropylene polyamine, and derivatives thereof, 2) acrylic polymers having a secondary amino group, tertiary amino group, or quaternary ammonium group, and acrylamide copolymers thereof; 3) polyvinylamines and polyvinylamidines; 4) dicyan-based cationic compounds exemplified by dicyandiamide-formalin copolymers; 5) polyamine-based cationic compounds exemplified by dicyandiamide-polyethyleneamine copolymers; 6) epichlorohydrin-dimethylamine copolymers; 7) diallyldimethyl ammonium—SO₂ polycondensation products; 8) diallylamine salt—SO₂ polycondensation products; 9) diallyldimethyl ammonium chloride polymers: 10) diallyldimethyl ammonium chloride-acrylamide copolymers; 11) copolymers of allylamine salts; 12) dialkylaminoethyl (meth)acrylate quaternary salt copolymers; 13) acrylamide-diallylamine copolymers; 14) cationic resins having a five-membered cyclic amidine structure, and the like.

The amount of the cationic compound with respect to 100 parts by mass of the pigment is preferably within the range of 1 to 30 parts by mass, and more preferably 3 to 20 parts by mass. If the amount of the cationic compound is less than 1 parts by mass, realization of print density improvement may be difficult. If the amount of the cationic compound is more than 30 parts by mass, there is a possibility in which the ink absorbing capability deteriorates and image bleeding or uneven print density occurs because the excess amount of the cationic compound fills spaces.

If the cationic compound is formulated, it is preferable that at least one portion of the cationic compound be previously mixed with the pigment. In particular, if the fine silica is used as the pigment, there is a case in which fine silica particles are agglomerated by adding the cationic compound to the fine silica particles to mix them, and thereby adjustment of the particle diameter thereof to the above-mentioned particular particle diameter is difficult, since the silica generally exhibits anionic properties.

In this case, it is preferable to use cationic fine silica with a particle diameter adjusted to the above-mentioned particular particle diameter by adopting a procedure in which the cationic compound is mixed with unpulverized noncrystalline silica (having a secondary particle diameter of several micrometers), followed by dispersing and pulverizing by applying a strong force using a mechanical device, or a procedure in which the cationic compound is mixed with a secondary particle dispersion of finely pulverized silica so that the viscosity thereof increases and agglomeration occurs, followed by dispersing and pulverizing using a mechanical device again. The cationic fine silica treated in such a way has characteristics in which agglomeration is hardly formed even if another cationic compound is additionally formulated, probably because the cationic fine silica forms a structure in which a portion of the cationic compound is bonded, and stably disperses in the slurry state.

As the cationic compound used to treat silica, the above-mentioned cationic compounds used to form the ink-fixing layer, and low-molecular-weight cationic compounds (such as, for example, cationic surfactants) are exemplified. The cationic resin is preferably used in terms of improvement of print density, and may be used as a water-soluble resin or an emulsion. Also, the cationic resin may be used as a cationic organic pigment in the form of particles insolubilized by performing cross-linking or the like. Such a cationic organic pigment is a cross-linked resin obtained by copolymerizing a polyfunctional monomer with a cationic resin, or obtained by adding a cross-linking agent, as needed, to a cationic resin with a reactive functional group (such as, for example, a hydroxyl group, a carboxyl group, an amino group, or an acetoacetyl group) followed by exposing to heat, radiation, or the like to perform cross-linking. The cationic compound, particularly cationic resin may serve as an adhesive.

(Others with Respect to Ink-Fixing Layer)

In the ink-fixing layer, various auxiliaries, such as, for example, preservability-improvers, antifoamers, coloring agents, fluorescent brighteners, antistats, antiseptics, dispersants, or thickeners may be further suitably formulated.

The ink-fixing layer may be formed by coating and drying on the solvent-absorbing layer. The coating of the ink-fixing layer may be performed using various known coating devices such as a blade coater, air knife coater, roll coater, brush coater, champflex coater, bar coater, lip coater, gravure coater, curtain coater, slot die coater, slide coater, spray, or the like. Among them, an air knife coater, lip coater, slide coater, curtain coater, or slot die coater is preferably used.

A coating liquid for the ink-fixing layer is generally adjusted to have a solid concentration of approximately 5 to 50% by mass. The preferable solid concentration thereof is approximately 5 to 20% by mass. The coating amount of the coating liquid for the ink-fixing layer in dry mass is generally 1 to 30 g/m², preferably 1.5 to 20 g/m², more preferably 2 to 15 g/m², and even more preferably 2 to 10 g/m². If the coating amount is excessively small, insufficient fixability of dye or pigment contained in ink tends to occur. If the coating amount is excessively large, insufficient print density tends to occur.

### (Mirror Finish of Ink-Fixing Layer Surface)

In the first aspect of the present invention, the surface of the ink-fixing layer is mirror-finished. In this case, a so-called casting method is adopted, in which, while the ink-fixing layer formed by coating is in a wet state, the ink-fixing layer is brought into press contact with a mirrored surface, such as, for example, a heated mirror-finished roll (such as a cast drum), followed by drying, to obtain an ink-jet recording sheet with a high glossiness. As the casting method, a known wet method, rewet method, or solidification method may be adopted. Although it is preferable that the mirror-finished roll such as a cast drum be used, a film with a high smoothness or the like may be used to impart glossiness.

In this case, the coating amount of the coating liquid for the ink-fixing layer in a dry mass is preferably within the range of 2 to 15 g/m², more preferably 2 to 10 g/m², and even more preferably 3 to 8 g/m². In the case where gloss-finish is performed using a mirror-finished roll, cast-processing can realize excellent glossiness and improved ink absorbing capability by setting the coating amount to 2 g/m² or more. By setting the coating amount to 15 g/m² or less, cracking of the coating layer is prevented and improved dot-roundness is realized when ink-jet recording is performed.

### (Favorable Ink-Fixing Layer)

A further favorable ink-fixing layer is a layer formed by forming a film by increasing the viscosity of a coating liquid containing a fine pigment and an adhesive, or cross-linking the coating liquid, while applying the coating liquid, or by drying a coating layer formed by application of the coating liquid before the coating layer exhibits a decreasing drying rate. When such a layer is formed, an obtained ink-fixing layer exhibits excellent printing suitability not only to dye ink but also to pigment ink without cracking occurring on the surface thereof, and further has a surface with a high-smoothness. In more detail, the following methods (A) to (C) are exemplified, and these methods may be suitably adopted. However, a method is not limited to these methods.

The following are exemplified.

(A) A method in which a coating liquid containing a hydrophilic resin which forms a hydrogel by electron irradiation is applied to form a coating layer, and the viscosity of the coating layer is increased (hydrogel is formed) by electron irradiation, immediately after applying the coating liquid, or during drying the coating layer but before the coating layer exhibits a decreasing drying rate.
(B) A method in which a coating liquid for an ink-fixing layer containing an adhesive is applied, and the viscosity of the coating liquid is increased and the coating liquid is cross-linked using a compound having a cross-linkability with the adhesive immediately after applying the coating liquid, or by drying the ink-fixing layer before the ink-fixing layer exhibits a decreasing drying rate.
(C) A method in which a coating liquid for an ink-fixing layer containing a temperature-sensitive polymer compound reversibly exhibiting hydrophilicity or hydrophobicity depending on temperature change, the temperature-sensitive polymer compound increasing the viscosity of the coating liquid or gelatinizing the coating liquid in the temperature region where the temperature-sensitive polymer compound exhibits hydrophilicity, is applied in the temperature region where the temperature-sensitive polymer compound exhibits hydrophobicity, and then the temperature of the ink-fixing layer is raised to the temperature region where the temperature-sensitive polymer compound exhibits hydrophilicity.

### Method (A)

In the case where an ink-fixing layer is formed by the method (A), a coating liquid containing 1 to 100 parts by mass of a hydrophilic adhesive with respect to 100 parts by mass of a pigment, the hydrophilic adhesive being free from radical-polymerizable unsaturated bond and forming a hydrogel when an aqueous solution thereof is exposed to an electron beam, is applied, and then the applied coating liquid was hydrogelated by exposing it to an electron beam, followed by drying it to form the ink-fixing layer.

Examples of the hydrophilic adhesive free from a radical-polymerizable unsaturated bond, the hydrophilic adhesive forming a hydrogel when an aqueous solution thereof is exposed to an electron beam, include polyvinyl alcohol, polyethyleneoxide, polyalkylenoxide, polyvinylpyrrolidone, water-soluble polyvinylacetal, poly-N-vinylacetamide, polyacrylamide, polyacryloylmorpholine, polyhydroxyalkylacrylate, polyacrylic acid, hydroxyethyl cellulose, methyl cellulose, hydroxypropyl methyl cellulose, hydroxypropyl cellulose, gelatin, casein, water-soluble derivatives thereof, copolymers thereof, and the like. These may be used alone or in combination.

As a method for radiating an electron beam, a scanning method, curtain beam method, broad beam method, or the like may be adopted. It is preferable that the accelerating voltage at the time of radiating electron beam be approximately within the range of 50 to 300 kv. It is preferable that the irradiance level of the electron beam be adjusted to be approximately within the range of 1 to 200 kGy. If the irradiance level is less than 1 kGy, there is a possibility of the coating layer not being sufficiently gelatinized. If the irradiance level is more than 200 kGy, there is a possibility of deterioration or discoloration of the base material or coating layer occurring, which is unfavorable.

As a method for performing electron irradiation, a method in which application, electron irradiation, and drying are repeatedly performed (1); a method in which another coating liquid is applied and dried on a coating layer previously formed by performing application and electron irradiation (2); or a method in which plural layers are simultaneously formed by performing application and electron irradiation (3), may be adopted, for example.

### Method (B)

In the case where an ink-fixing layer is formed by the method (B), an adhesive known to be used to produce an ink-jet recording sheet can be used. Examples thereof include polyvinyl alcohol, polyvinylpyrrolidone, casein, soybean protein, synthetic proteins, starch, carboxymethyl cellulose, methyl cellulose, other cellulose derivatives, and other water-soluble resins. In particular, polyvinyl alcohol that exhibits high adhesiveness to the pigment is preferably used. In particular, polyvinyl alcohol with a polymerization degree of 2,000 or more, more preferably polyvinyl alcohol with a polymerization degree of 3,600 to 5,000, is preferably used so as to realize a favorable balance between film-formability and ink absorbing capability. In order to improve ink absorbing capability, at least two kinds of adhesive materials (such as, for example, a mixture of at least two kinds of water-soluble resins, or a mixture of at least one water-soluble resin and at least one latex) may be used.

As the compound having a cross-linkability with the adhesive, various known cross-linking agents and gelatinizing agents may be used. Examples of a compound having a cross-linkability with polyvinyl alcohol include aldehyde-based cross-linking agents such as glyoxal, epoxy-based cross-linking agents such as ethyleneglycoldiglycidyl ether, vinyl-based cross-linking agents such as bisvinylsulfonylmethyl ether, boron-containing compounds such as boric acid and borax, glycidyl compounds, zirconium compounds, aluminium compounds, chromium compound, and the like. Among them, the boron-containing compounds are particularly preferable because viscosity-increase or gelatinization rapidly occurs.

The term “boron-containing compounds” refers to oxygen acids containing a boron atom as the central atom thereof and salts thereof. Examples thereof include orthoboric acid, metaboric acid, hypoboric acid, tetraboric acid, and pentaboric acid, and sodium salts thereof, potassium salts thereof, and ammonium salts thereof. Among them, orthoboric acid and disodium tetraborate are preferably used because they can suitably increase the viscosity of a coating liquid.

It is preferable that the boron compound be contained on one surface of a base material in an amount of 0.01 to 2.0 g/m² although the amount of the boron compound depends on the kind thereof and the polymerization degree of polyvinyl alcohol. If the amount is greater than 2.0 g/m², the density of cross-linking with the hydrophilic adhesive tends to be so high that the coating film is so hard as to be easily cracked. If the amount is less than 0.01 g/m², the cross-linking with the hydrophilic adhesive tends to be insufficient and the gelatinization of the coating liquid tends also to be insufficient, and thereby the formed coating film is easily cracked.

For example, the ink-fixing layer may be formed by a procedure in which a cross-linking agent is previously applied on or absorbed in a solvent-absorbing layer, followed by applying a coating liquid for an ink-fixing layer thereon, a procedure in which a cross-linking agent is formulated in a coating liquid for an ink-fixing layer, followed by applying the coating liquid, or a procedure in which a coating liquid for an ink-fixing layer is applied, followed by applying a cross-linking agent thereon. Among them, the procedure in which a cross-linking agent is previously applied is preferable because the viscosity increase or gelatinization of the ink-fixing layer is uniformly realized.

### Method (C)

In the case where an ink-fixing layer is formed by the method (C), a temperature-sensitive polymer compound reversibly exhibiting hydrophilicity or hydrophobicity depending on temperature change, the temperature-sensitive polymer compound increasing the viscosity of a coating liquid or gelatinizing the coating liquid in the temperature region where the temperature-sensitive polymer compound exhibits hydrophilicity is preferably used as an adhesive. The temperature in which the hydrophilicity and hydrophobicity of the temperature-sensitive polymer compound are converted is referred to as a “temperature-sensitive point”. The temperature-sensitive polymer compound may be formulated as the main component of the adhesive in the ink-fixing layer.

The coating liquid containing the temperature-sensitive polymer compound is easily applied without increasing the viscosity thereof by applying the coating liquid in the temperature region where the temperature-sensitive polymer compound exhibits hydrophobicity. After the application, the coating layer is gelatinized by changing the temperature of the coating liquid to the temperature region where the temperature-sensitive polymer compound exhibits hydrophilicity. Then, the coating layer is dried to form an ink-fixing layer.

The temperature-sensitive polymer compound reversibly exhibiting hydrophilicity or hydrophobicity depending on temperature change, the temperature-sensitive polymer compound increasing the viscosity of a coating liquid or gelatinizing the coating liquid in the temperature region where the temperature-sensitive polymer compound exhibits hydrophilicity, is a compound that exhibits different properties of hydrophilicity and hydrophobicity between over and below the temperature-sensitive point.

As such a compound, (1) temperature-sensitive polymer compounds that exhibit hydrophobicity in a temperature region no lower than the temperature-sensitive point, but exhibit hydrophilicity in a temperature region lower than the temperature-sensitive point; and (2) temperature-sensitive polymer compounds that exhibit hydrophobicity in a temperature region no higher than the temperature-sensitive point, but exhibit hydrophilicity in a temperature region higher than the temperature-sensitive point may be used. When the temperature-sensitive polymer compound exhibits hydrophilicity, the temperature-sensitive polymer compound in a system where the temperature-sensitive polymer compound and water coexist is stable in the state in which the temperature-sensitive polymer compound is compatible with water in comparison with that in the state in which the temperature-sensitive polymer compound is phase-separated from water. When the temperature-sensitive polymer compound exhibits hydrophobicity, the temperature-sensitive polymer compound in a system where the temperature-sensitive polymer compound and water coexist is stable in the state in which the temperature-sensitive polymer compound is phase-separated from water in comparison with that in the state in which the temperature-sensitive polymer compound is compatible with water.

According to the present invention, (1) the temperature-sensitive polymer compounds that exhibit hydrophilicity in a temperature region lower than the particular temperature, but exhibit hydrophobicity in a temperature region no lower than the particular temperature are preferably used. A polymeric emulsion containing such a temperature-sensitive polymer compound may be prepared as disclosed in Japanese Laid-Open Patent Application No. 2003-040916, for example.

That is, a polymerization reaction is performed using the above-mentioned monomer in the coexistence of polyvinyl alcohol and/or polyvinyl alcohol derivatives in the temperature region no lower than the temperature-sensitive point of the temperature-sensitive polymer compound. In more detail, a method in which emulsion polymerization is performed by dissolving a surfactant in water, adding thereto the above-mentioned polyvinyl alcohol and/or polyvinyl alcohol derivatives, and copolymerizable monomer components such as a main monomer (M) and a submonomer (N), emulsifying them, and then adding a radical polymerization initiator thereto at once, is exemplified as well as a method in which the above-mentioned copolymerizable monomer components and a radical polymerization initiator are supplied in a reaction system by a continuous dropping method, a divisional addition method, or the like.

Such a polymeric emulsion is commercially available from Asahi Kasei Corporation under the trade name of ALB-8.01, ALB-22.03, or the like, as a temperature-sensitive resin.

A coating liquid for the ink-fixing layer is obtained by mixing the polymeric emulsion, a pigment, and arbitrary components together.

It is preferable that the coating liquid for an ink-fixing layer be heated or warmed to the temperature no lower than the temperature-sensitive point after preparation thereof but before use for application, and be cooled to the temperature lower than the temperature-sensitive point to gelatinize the ink-fixing layer after application, followed by drying.

In the case of the compound (2), a coating liquid with a temperature no higher than the temperature-sensitive point is applied, and then heated to the temperature higher than the temperature-sensitive point so that the viscosity of the coating liquid is increased or the coating liquid is gelatinized. As such a compound, compounds disclosed in Japanese Patent Application. First Publication No. H8-244334 are exemplified. For example, the viscosity of the coating layer is increased or the coating layer is gelatinized by heating the coating surface thereof using a hot air generator, infrared heater, or the like, to raise the temperature thereof.

Such a favorable ink-fixing layer may be subjected to mirror-finishing while the ink-fixing layer is in a wet state.

### “Glossy Layer”

In the second aspect of the present invention, it is effective that a glossy layer be provided on the ink-fixing-layer so as to increase the glossiness. The glossy layer has as its main object the provision of glossiness, and is not particularly required to exhibit dye-fixing properties.

The glossy layer is formed by applying a coating liquid for the glossy layer on the ink-fixing layer, followed by, while the coating liquid is in a wet state or in a rewet state, bringing it into press contact with a heated mirror-finished drum and then drying.

A pigment contained in the glossy layer is selected from the group consisting of monodispersed colloidal pigments with an average primary particle diameter of 0.01 to 0.06 μm, aluminium oxides with an average particle diameter of 1 μm or less, and pseudoboehmite fine pigments. Among them, monodispersed colloidal silica with an average primary particle diameter of 0.01 to 0.06 μm realizes favorable glossiness. A cation-modified colloidal silica is one type of the monodispersed colloidal silica. Also, the aluminium oxides and pseudoboehmites are preferable in terms of scratch resistance of pigment-ink suitability.

The glossy layer may suitably contain the adhesive exemplified as one to be formulated in the above-mentioned solvent-absorbing layer or the ink-fixing layer, provided that the ink absorbing capability is not inhibited.

It is preferable that a release agent be formulated in the glossy layer so that the glossy layer is easily separated from a mirror-finished drum during manufacturing.

Examples of the release agent include: higher fatty acid amides such as stearic acid amide, oleic acid amide, and the like; polyolefin waxes such as polyethylene wax, oxidized polyethylene wax, polypropylene wax, and the like; alkaline salts of higher fatty acid such as calcium stearate, zinc stearate, potassium oleate, ammonium oleate, and the like; silicone compounds such as lecithin, silicone oil, silicone wax, and the like; and fluorine compounds such as polytetrafluoroethylene, and the like.

It is preferable that the formulation amount of the release agent with respect to 100 parts by mass of the pigment be adjusted to 0.1 to 50 parts by mass, more preferably 0.3 to 30 parts by mass, and even more preferably 0.5 to 20 parts by mass. If the formulation amount is extremely small, there is a case in which effects of improving releasability are not sufficiently realized. If the formulation amount is extremely large, there is a case in which the deterioration of glossiness, cissing of ink, or decrease of recording density occurs.

Various auxiliaries such as pigments, antifoamers, coloring agents, fluorescent brighteners antistats, antiseptics, dispersants, thickener, or the like, which are generally used to produce coated paper for printing or ink-jet sheet, may be suitably formulated in a coating composition for the glossy layer so as to adjust whiteness degree, viscosity, fluidity, or the like.

In order to apply a coating liquid for the glossy layer on the ink-fixing layer, various known coating apparatuses, such as, for example, a blade coater, air knife coater, roll coater, brush coater, champflex coater, bar coater, lip coater, gravure coater, curtain coater, slot die coater, slide coater, or the like, may be used. According to the present invention, the glossy layer is a layer subjected to mirrored finish. A preferable method is a casting method in which a coating layer in a wet state is dried on a mirror-finished drum (cast drum) with a smooth surface to copy the smooth surface onto the coating layer, as a result of which a coating layer surface with smoothness and glossiness is formed. Also, the glossiness may be imparted using a film with a high-smoothness.

As a method for forming the glossy layer using the mirror-finished drum, a method (wet casting method) in which the coating liquid for the glossy layer is applied on the ink-fixing layer, followed by, while the coating layer is in a wet state, bringing it into press contact with a heated mirror-finished drum and then drying; a method (rewet casting method) in which the coating layer is dried, and then rewetted, followed by bringing it into press contact with the heated mirror-finished drum, and then drying; and a method (gel casting method) in which the coating layer is solidified in a gel state where the coating layer does not exhibit fluidity but exhibits deformability, followed by bringing it into press contact with the heated mirror-finished drum, and then drying, are exemplified. Also, a method (precasting method) in which the coating liquid for the glossy layer is directly applied on the heated mirror-finished drum, followed by bringing it into press contact with the ink-fixing layer formed on the paper support, and then drying to laminate may be adopted.

It is preferable that the surface temperature of the mirror-finished drum be approximately within the range of 40 to 200° C., and more preferably 70 to 150° C. If the surface temperature is lower than 40° C., it takes a long time to dry, film-formation tends to be insufficient, and the glossiness tends to deteriorate. If the surface temperature is higher than 200° C., there is not only a case in which film-formation excessively proceeds, and thereby the surface porosity decreases, as a result of which ink-absorbing rate decreases, but also a case in which the sheet surface is roughened and the glossiness thereof deteriorates.

When the coating liquid for the glossy layer is applied on the ink-fixing layer, followed by, while the ink-fixing layer and the glossy layer are in a wet state, bringing it into press contact with a heated mirror-finished drum, and then drying, a procedure in which immobilization of the coating liquid for the glossy layer is accelerated may be adopted so as to prevent immersion of the coating liquid for the glossy layer into the ink-fixing layer.

As such a procedure, (1) one in which a gelatinizing agent that accelerates immobilization of the coating liquid for the glossy layer is formulated in the ink-fixing layer; (2) one in which a gelatinizing agent that accelerates immobilization of the coating liquid for the glossy layer is applied on or immersed into the ink-fixing layer; (3) one in which a coating liquid for the glossy layer is applied, and then a gelatinizing agent that accelerates immobilization of the coating liquid for the glossy layer is applied on or immersed in the surface thereof, and (4) one in which a gelatinizing agent that accelerates immobilization during drying the coating liquid for the glossy layer is formulated in the coating liquid for the glossy layer, are exemplified.

Examples of such a gelatinizing agent include boric acids, formic acids, other agents for cross-linking the adhesive in the coating liquid for the glossy layer, salts thereof, aldehyde compounds, epoxy compounds, and the like. In the case where the wet casting method is adopted, the glossiness is easily realized by preventing immersion of the coating liquid for the glossy layer by shortening the time period required for bringing into press contact with a mirror-finished drum and then drying after applying the coating liquid on the ink-fixing layer.

Moreover, a method (referred to as a nip casting method) in which the coating liquid for the glossy layer is supplied between the ink-fixing layer surface on a press roll and the mirror-finished drum immediately before the ink-fixing layer surface is brought into press contact with the drum, and then press contact is immediately performed, is particularly preferable, because immersion of the coating liquid is suppressed as much as possible, and favorable glossiness and print quality are easily realized by using a small amount of the coating liquid.

It is preferable that the coating amount of the glossy layer in a dry solid content be approximately within the range of 0.1 to 20 g/m², more preferably 0.2 to 10 g/m², and even more preferably 0.5 to 5 g/m². If the coating amount is less than 0.1 g/m², it is difficult to realize sufficient glossiness. If the coating amount is greater than 20 g/m², bleeding tends to easily occur and print density tends to be insufficient at the time of printing. Moreover, a smoothing treatment may be performed by supercalendering or the like after cast-finishing is performed.

It is preferable that the 75° glossiness (according to JIS P8142) of the surface of the surface layer be 60% or more, more preferably 65% or more, and even more preferably 70% or more, so as to realize texture of photographic paper.

### “Other Coating Layers”

According to the present invention, other coating layers may be formed between the paper support and the solvent-absorbing layer so as to improve adhesiveness between the paper support and the solvent-absorbing layer and to further improve the ink absorbing capability. Also, a rear surface layer may be formed so as to improve curl-preventability or transferability. Also, a polyethylene layer may be formed as the rear surface layer so as to realize a photographic texture.

Also, a known recording layer for realizing recording suitability such as ink-jet recording suitability, thermosensitive recording suitability, thermal transfer recording suitability, magnetic recording suitability, or the like, and an adhesive layer composed of a tackiness agent or adhesive may be formed on the other surface of the paper support. Also, another support may be adhered together.

### EXAMPLES

In the following, the present invention will be more circumstantially explained by way of examples. Herein, the terms “parts” and “%” indicates “parts by mass” and “% by mass”, respectively, unless otherwise so indicated.

### “Preparation of Paper Support”

A high-quality paper with a basis weight of 175 g/m² was produced using a Fourdrinier-type paper-making apparatus using paper-making raw materials composed of 100 parts of wood pulp (LBKP: chlorine-free pulp with a freeness of 450 ml CSF, prepared by four-stage sequence Ze-E-P-D), 5 parts of filler (composed of calcium carbonate and talc at a ratio of 1 to 1), 0.04 parts of commercially available sizing agent, 0.45 parts of aluminum sulfate, 1.00 parts of starch, and a slight amount of yield-improver. Then, the high-quality paper was subjected to drying, size-pressing, and supercalendering treatment at a linear pressure of 100 kg/cm to obtain a paper support.

The thickness of the obtained paper support was 200 μm.

### [Silica Particle A]

A fumed silica with an average particle diameter of 1.0 μm (manufactured by NIPPON AEROSIL CO., LTD., under the trade name of AEROSIL A300, with an average primary particle diameter of approximately 0.008 μm) was dispersed using a sand grinder, followed by further dispersing using a pressure-type homogenizer. The dispersing processes using the sand grinder and the pressure-type homogenizer were repeatedly performed until the average particle diameter became 0.08 μm, and then 10% aqueous dispersion was prepared.

10 parts by mass of a cationic compound with a five-membered amidine structure (manufactured by HYMO Co., Ltd., under the trade name of SC-700, with a molecular weight of 300,000) was added to the 10% aqueous dispersion, and dispersed using a sand grinder, followed by further dispersing using a pressure-type homogenizer. The dispersing processes were repeatedly performed until the average particle diameter became 0.15 μm, and then 10% aqueous dispersion was prepared.

### [Silica Particle B]

A wet silica with an average particle diameter of 2.0 μm (manufactured by Nippon Silica Industrial Co., Ltd., under the trademark of Nipsil HD, with an average primary particle diameter of approximately 0.013 μm) was dispersed using a sand grinder, and then further dispersed using a pressure-type homogenizer, followed by repeatedly performing the dispersing processes using the sand grinder and the pressure-type homogenizer until the average particle diameter became 0.4 μm, and then preparing 10% aqueous dispersion of the wet silica.

10 parts of a cationic compound with a five-membered amidine structure (manufactured by HYMO Co., Ltd., under the trade name of SC-700, with a molecular weight of 300,000) was added to the 10% aqueous dispersion, and then dispersed using a sand grinder, followed by further dispersing using a pressure-type homogenizer. The dispersing processes using the sand grinder and the pressure-type homogenizer were repeatedly performed until the average particle diameter became 0.8 μm, and the 10% aqueous dispersion was prepared.

### Example 1

### Formation of Solvent-Absorbing Layer

On the obtained paper support, the following coating liquid for a solvent-absorbing layer was applied and dried using an air knife coater so that the dry mass thereof was 10 g/m².

[Preparation of Coating Liquid for Solvent-Absorbing Layer]

100 parts of synthetic noncrystalline silica (manufactured by TOKUYAMA Corp., under the trademark of FINESIL X-30, with an average secondary particle diameter of 3.2 μm), 20 parts of silyl-modified polyvinyl alcohol (manufactured by KURARAY CO., LTD., under the trade name of R1130) and 20 parts of ternary copolymer composed of n-butyl acrylate-N-methylolacrylamide-styrene (emulsion type) as adhesives, and 3 parts of cationic compound (manufactured by SENKA CORPORATION under the trademark of UNISENCE CP104) were mixed, and an 18% aqueous solution was prepared.

“Forming of Ink-Fixing Layer and Mirrored-Finish┘

On the obtained solvent-absorbing layer, water was applied using a roll coater in an amount of 0.5 g/m², and then, while the solvent-absorbing layer was in a wet state, the following coating liquid for an ink-fixing layer was applied thereon using a die coater in a dry mass of 5 g/m² followed by bringing the ink-fixing layer into press contact with a mirror-finished drum, while the ink-fixing layer was in a wet state, and then drying to finish. Thus, a glossy ink-jet recording sheet containing the solvent-absorbing layer and the ink-fixing layer was obtained.

[Preparation of Coating Liquid for Ink-Fixing Layer]

20 parts of polyvinyl alcohol with a polymerization degree of 7,500 and a saponification degree of 98% as an adhesive, and 5 parts of cation-modified acrylic resins were mixed with 100 parts of the silica fine particle A to prepare a 5% aqueous solution.

### Comparative Example 1

A glossy ink-jet recording sheet containing a solvent-absorbing layer and a ink-fixing layer was prepared in a similar way to that of Example 1, except that no ternary copolymer composed of n-butyl acrylate-N-methylolacrylamide-styrene (emulsion type) was formulated in a coating liquid for the solvent-absorbing layer.

### Example 2

### Formation of Solvent-Absorbing Layer

On the obtained paper support, the following coating liquid for a solvent-absorbing layer was applied and dried using an air knife coater so that the dry mass thereof was 10 g/m².

[Preparation of Solvent-Absorbing Layer]

100 parts of synthetic noncrystalline silica (manufactured by TOKUYAMA Corp., under the trademark of FINESIL X-30, with an average secondary particle diameter of 3.2 μm), 20 parts of silyl-modified polyvinyl alcohol (manufactured by KURARAY CO., LTD under the trade name of R1130) and 20 parts of ternary copolymer composed of n-butyl acrylate-N-methylolacrylamide-styrene (emulsion type) as adhesives, and 3 parts of cationic compound (manufactured by SENKA CORPORATION under the trademark of UNISENCE CP104) were mixed, and an 18% aqueous solution was prepared.

“Formation of Ink-Fixing Layer”

On the obtained solvent-absorbing layer, water was applied in an amount of 0.5 g/m² using a roll coater, and then, while the solvent-absorbing layer was in a wet state, the following coating liquid for an ink-fixing layer was applied and dried using a die coater so that the dry mass thereof was 5 g/m². Thus, an ink-fixing layer was formed.

[Preparation of Coating Liquid for Ink-Fixing Layer]

100 parts of silica fine particle A, 20 parts of polyvinyl alcohol with a polymerization degree of 7,500 and a saponification degree of 98% as an adhesive, and 5 parts of cation-modified acrylic resin were mixed to prepare a 5% aqueous solution.

“Formation of Glossy Layer”

On the ink-fixing layer, the following coating liquid for a glossy layer was applied at a nip portion between a mirror-finished drum and a press roll so that the dry mass thereof was 1 g/m², and simultaneously brought into press contact with the mirror-finished drum and dried. Thus, a glossy ink-jet recording sheet having the solvent-absorbing layer, the ink-fixing layer, and the glossy layer was obtained.

[Preparation of Coating Liquid for Glossy Layer]

5 parts of cation-modified acrylic emulsion latex (manufactured by Mitsui Chemicals, Inc., under the trade name of XOM-3020) as an adhesive and 5 parts of ammonium oleate were mixed with 100 parts of monodispersed colloidal silica (manufactured by NISSAN CHEMICAL INDUSTRIES, LTD., under the trade name of ST-OL, with an average particle diameter of 0.045 μm) to prepare a 5% aqueous solution.

### Comparative Example 2

A glossy ink-jet recording sheet having a solvent-absorbing layer, an ink-fixing layer, and a glossy layer was obtained in a similar manner to that of Example 2, except that no ternary copolymer composed of n-butyl acrylate-N-methylolacrylamide-styrene (emulsion type) was formulated in a coating liquid for the solvent-absorbing layer.

### Example 3

“Formation of Solvent-Absorbing Layer”

On the obtained paper support, the following coating liquid for a solvent-absorbing layer was applied and dried using an air knife coater so that the dry mass thereof was 10 g/m².

[Preparation of Coating Liquid for Solvent-Absorbing Layer]

100 parts of synthetic noncrystalline silica (manufactured by TOKUYAMA Corp., under the trademark of FINESIL X-30, with an average secondary particle diameter of average secondary particle diameter of 3.2 μm), 20 parts of silyl-modified polyvinyl alcohol (manufactured by KURARAY CO., LTD, under the trade name of R1130) and 20 parts of ternary copolymer composed of n-butyl acrylate —N-methylolacrylamide-styrene (emulsion type) as adhesives, and 3 parts of cationic compound (manufactured by SENKA CORPORATION, under the trademark of UNISENCE CP104) were mixed to prepare an 18% aqueous solution.

“Formation of Ink-Fixing Layer and Mirrored Finish”

On the solvent-absorbing layer, a 3% borax aqueous solution was applied using a roll coater at a dry mass of 0.5 g/m², followed by applying the following coating liquid for an ink-fixing layer using a die coater at a dry mass of 5 g/m², in accordance with a wet-on-wet coating method (in which two or more layers are formed by coating the upper layer on the lower layer while the lower layer is not dried). Then, while the ink-fixing layer was in a wet state, the ink-fixing layer was brought into press contact with the mirror-finished drum and dried to finish, and thus, a glossy ink-jet recording sheet having a solvent-absorbing layer and an ink-fixing layer was obtained.

[Preparation of Coating Liquid for Ink-Fixing Layer]

17 parts of polyvinyl alcohol (manufactured by KURARAY CO., LTD., under the trade name of PVA-135, with a polymerization degree of 3,500 and a saponification degree of 98.5%) as an adhesive was mixed with 100 parts of the silica fine particle A to prepare an 8% aqueous solution.

### Example 4

### Formation of Solvent-Absorbing Layer On the obtained paper support, the following coating liquid for a solvent-absorbing layer was applied and dried using an air knife coater so that the dry mass thereof was 10 g/m².

[Preparation of Coating Liquid for Solvent-Absorbing Layer]

100 parts of synthetic noncrystalline silica (manufactured by TOKUYAMA Corp. under the trademark of FINESIL X-30, with an average secondary particle diameter of 3.2 μm), 20 parts of silyl-modified polyvinyl alcohol (manufactured by KURARAY CO., LTD., under the trade name of R1130) and 20 parts of ternary copolymer composed of n-butyl acrylate-N-methylolacrylamide-styrene copolymer (emulsion type) as adhesives, and 3 parts of cationic compound (manufactured by SENKA CORPORATION under the trademark of UNISENCE CP104) were mixed to prepare an 18% aqueous solution.

“Formation of Ink-Fixing Layer”

On the solvent-absorbing layer, a 3% borax aqueous solution was applied using a roll coater at a dry mass of 0.5 g/m², followed by applying the following coating liquid for an ink-fixing layer using a die coater at a dry mass of 5 g/m² in accordance with a wet-on-wet coating method (in which two or more layers are formed by coating the upper layer on the lower layer while the lower layer is not dried) and then drying. Thus, an ink-fixing layer was formed.

[Preparation of Ink-Fixing Layer]

17 parts of polyvinyl alcohol (manufactured by KURARAY CO., LTD., under the trade name of PVA-135 with a polymerization degree of 3,500 and a saponification degree of 98.5%) as an adhesive was mixed with 100 parts of the silica fine particle A to prepare an 8% aqueous solution.

“Formation of Glossy layer”

On the ink-fixing layer, the following coating liquid for a glossy layer was applied at a nip portion between a mirror-finished drum and a press roll in a dry mass of 1 g/m², and simultaneously brought into press contact with the mirror-finished drum and dried. Thus, a glossy ink-jet recording sheet having the solvent-absorbing layer, the ink-fixing layer, and the glossy layer was obtained.

[Preparation of Coating Liquid for Glossy Layer]

5 parts of cation-modified acrylic emulsion latex (manufactured by Mitsui Chemicals, Inc., under the trade name of XOM-3020) as an adhesive and 5 parts of ammonium oleate were mixed with 100 parts of monodispersed colloidal silica (manufactured by NISSAN CHEMICAL INDUSTRIES, LTD., under the trade name of ST-OL, with an average particle diameter of 0.045 μm) to prepare a 5% aqueous solution.

### Comparative Example 3

A glossy ink-jet recording sheet having a solvent-absorbing layer and an ink-fixing layer was obtained in a similar way to that of Example 3, except that no ternary copolymer composed of n-butyl acrylate-N-methylolacrylamide-styrene (emulsion type) was formulated in a coating liquid for a solvent-absorbing layer.

### Comparative Example 4

A glossy ink-jet recording sheet having a solvent-absorbing layer and an ink-fixing layer was obtained in a similar way to that of Example 3, except that 20 parts of urethane-based resin (manufactured by DAI-ICHI KOGYO SEIYAKU CO., LTD., under the trademark of SUPERFLEX 600) was formulated as an adhesive instead of 20 parts of ternary copolymer composed of n-butyl acrylate-N-methylolacrylamide-styrene copolymer (emulsion type) in a coating liquid for the solvent-absorbing layer.

### Comparative Example 5

A glossy ink-jet recording sheet having a solvent-absorbing layer and an ink-fixing layer was obtained in a similar way to that of Example 3, except that 20 parts of acrylic resin (manufactured by Rohm and Haas Company under the trademark of PRIMAL P-376) was formulated as an adhesive instead of 20 parts of ternary copolymer composed of n-butyl acrylate-N-methylolacrylamide-styrene copolymer (emulsion type) in a coating liquid for the solvent-absorbing layer.

### Comparative Example 6

An ink-jet recording sheet having a solvent-absorbing layer and an ink-fixing layer was obtained in a similar way to that of Example 3, except that 40 parts of silyl-modified polyvinyl alcohol (manufactured by KURARAY CO., LTD., under the trade name of R1130) was formulated as an adhesive instead of the adhesives composed of 20 parts of silyl-modified polyvinyl alcohol (manufactured by KURARAY CO., LTD., under the trade name of R1130) and 20 parts of ternary copolymer composed of n-butyl acrylate-N-methylolacrylamide-styrene copolymer (emulsion type) in a coating liquid for the solvent-absorbing layer.

### Comparative Example 7

An ink-jet recording sheet having a solvent-absorbing layer and an ink-fixing layer was obtained in a similar way to that of Example 1, except that the silica fine particle B was used instead of the silica fine particle A to prepare a coating liquid for an ink-fixing layer.

Each ink-jet recording sheet obtained in such ways were evaluated as follows and results thereof are shown in Table 1.

Ink Absorbing Capability (Print Spot)

Green ink was solidly printed on the ink-jet recording sheet, and the existence of solid print spots was checked with the naked eyes to evaluate it in four stages as follows. The print spot is generated when an ink droplet which is previously delivered but is not completely absorbed in a coating layer of an ink-jet recording sheet is overlapped with another ink droplet which is sequentially delivered, the print spot significantly occurring when ink-absorbing rate is slow. Printing was performed using a commercially available dye ink-jet printer (manufactured by SEIKO EPSON CORPORATION under the trade name of PM-G800, used in print mode of PM photo paper fine mode).

A: No print spots were recognized.

B: Few print spots were recognized, but no practical problems arose.

C: Print spots were recognized and practical problems arose.

D: Many print spots were recognized.

Image Evenness (Dot Roundness)

The ISO-400 image (“High-resolution color digital standard image data ISO/JIS-SCID”, page 13, image name: fruit basket) was printed on the ink-jet recording sheet, and evenness of the image (background portion) was checked with the naked eyes to evaluate it. If dots are round, a portion where many dots are overlapped is very even. In contrast, if dots are not round, the portion lacks evenness. Printing was performed using a commercially available dye ink-jet printer (manufactured by SEIKO EPSON CORPORATION under the trade name of PM-G800, used in print mode of PM photo paper fine mode).

A: Image was even and no spots were recognized (dot was round and no aliasing was recognized at edge portions).

B: Image was uneven and spots were recognized (dot was not round and aliasing was recognized at edge portions).

Print Density

Black ink was solidly printed on the ink-jet recording sheet and the print density was measured using a Macbeth reflection densitometer (manufactured by Macbeth under the trade name of RD-914). A high measured value indicates a high print density. Printing was performed using a commercially available dye ink-jet printer (manufactured by SEIKO EPSON CORPORATION under the trade name of PM-G800, used in print mode of PM photo paper fine mode).

Glossiness

The ISO-400 image (“High-resolution color digital standard image data ISO/JIS-SCID”, page 13, image name: fruit basket) was printed on the ink-jet recording sheet, and the glossiness was checked with the naked eyes in a horizontal direction with respect to the printed portion to evaluate it in four stages as follows. Printing was performed using a commercially available dye ink-jet printer (manufactured by SEIKO EPSON CORPORATION under the trade name of PM-G800, used in print mode of PM photo paper fine mode).

A: Glossiness at the same level as that of silver halide photography was recognized.

B: Glossiness at the level slightly inferior to that of silver halide photography was recognized.

C: Glossiness at the same level as that of commercially available glossy ink-jet recording sheet was recognized.

D: Glossiness at the level slightly inferior to that of commercially available glossy ink-jet recording sheet was recognized.

Coating Film Strength

On the outermost layer (ink-fixing layer or glossy layer) of the ink-jet recording sheet, an adhesive tape (manufactured by NICHIBAN CO., LTD., under the trademark of SELLOTAPE (R) CT12S) was adhered and then lightly pressed with the fingers, followed by removing it.

A: Almost no portion of the recording layer was removed.

B: The recording layer was slightly removed, but no practical problems arose.

C: The recording layer was mostly removed, and practical problems arose.

Recording Suitability for Pigment Ink

The ISO-400 image (“High-resolution color digital standard image data ISO/JIS-SCID”, page 13, image name: fruit basket) was recorded on the ink-jet recording sheet. The recording suitability for pigment ink was evaluated by evaluating the evenness of the recorded image.

A: Image was even and no spots were recognized.

B: Spots were recognized in the image, but practical use was possible.

C: So many spots were recognized in the image that practical use was impossible.

Scratch Resistance of Pigment Ink Image

The above-mentioned image was left still for 24 hours after recording, and then the image portion was scratched with a cotton-tipped swab to evaluate its scratch resistance as follows.

A: No change was recognized at the image portion.

B: A part of the pigment at the image portion was scraped away. However, no practical problems arose.

C: Most of the pigment at the image portion was scraped away, and practical problems arose.

TABLE 1

| | | | | | | Recording | Scratch |
|---|---|---|---|---|---|---|---|
| | Ink | | | | Coating | suitability | resistance |
| | absorbing | Image | Print | | film | for pigment | of pigment |
| | capability | evenness | density | Glossiness | strength | ink | ink image |
| Example 1 | B | A | 2.16 | C | A | A | A |
| Comparative | B | A | 2.17 | C | B | A | A |
| Example 1 | | | | | | | |
| Example 2 | B | A | 2.21 | A | A | A | B |
| Comparative | B | A | 2.20 | A | B | A | B |
| Example 2 | | | | | | | |
| Example 3 | A | A | 2.24 | B | A | A | A |
| Example 4 | A | A | 2.25 | A | A | A | B |
| Comparative | A | A | 2.20 | B | C | A | A |
| Example 3 | | | | | | | |
| Comparative | C | A | 2.10 | B | A | A | A |
| Example 4 | | | | | | | |
| Comparative | C | A | 2.13 | B | A | A | A |
| Example 5 | | | | | | | |
| Comparative | D | A | 2.05 | D | A | B | B |
| Example 6 | | | | | | | |
| Comparative | B | B | 2.00 | D | B | C | A |
| Example 7 | | | | | | | |

As is apparent from Table 1, the recording sheet according to the present invention realized no cracking in the ink-fixing layer, and thereby the ink absorbing capability thereof was favorable and image quality and image recording density were excellent, and the coating film strength was increased by using polyvinyl alcohol together with the ternary copolymer composed of alkyl(meth)acrylate, N-methylolacrylamide, and styrene as the adhesives in the solvent-absorbing layer. On the other hand, the ink-jet recording sheet of Comparative Examples 1 to 4, free from the ternary copolymer according to the present invention, exhibited a lack of ink absorbing capability and a lack of coating film strength.

### INDUSTRIAL APPLICABILITY

The ink-jet recording sheet according to the present invention provides a glossy ink-jet recording sheet suitable for dye ink-type ink-jet printers with a rapid ink-discharge rate for recording photo-quality images, and to a pigment ink-type ink-jet printers.

1. A glossy ink-jet recording sheet comprising: a paper support; a solvent-absorbing layer comprising a pigment and an adhesive; and an ink-fixing layer comprising a pigment and an adhesive, the ink-fixing layer having a mirror-finished surface; wherein the adhesive of the solvent-absorbing layer comprises a ternary copolymer consisting of an alkyl(meth)acrylate, a N-methylolacrylamide, and a styrene.

2. A glossy ink-jet recording sheet comprising: a paper support; a solvent-absorbing layer comprising a pigment and an adhesive; and a glossy layer having a mirror-finished surface; wherein the adhesive of the solvent-absorbing layer comprises a ternary copolymer consisting of an alkyl(meth)acrylate, a N-methylolacrylamide, and a styrene.

3. A glossy ink-jet recording sheet according to claim 1, wherein the pigment of the solvent-absorbing later has an average particle diameter of 1 μm or more and 20 μm or less.

4. A glossy ink-jet recording sheet according to claim 1, wherein the pigment of the ink-fixing layer is at least one selected from the group consisting of a silica, an aluminosilicate and an alumina, wherein the silica, the aluminosilicate, and the alumina are secondary particles having an average primary particle diameter of 0.003 μm or more and 0.04 μm or less, and an average secondary particle diameter of 0.01 μm or more and 0.7 μm or less; and wherein the adhesive of the ink-fixing layer mainly comprises a polyvinyl alcohol.

5. A glossy ink-jet recording sheet according to claim 4, wherein the ink-fixing layer further comprises a compound having a cross-linkability with the polyvinyl alcohol.

6. (canceled)

7. A glossy ink-jet recording sheet according to claim 2, wherein the pigment of the solvent-absorbing later has an average particle diameter of 1 μm or more and 20 μm or less.

8. A glossy ink-jet recording sheet according claim 2, wherein the pigment of the ink-fixing layer is at least one selected from the group consisting of a silica, an aluminosilicate and an alumina, wherein the silica, the aluminosilicate, and the alumina are secondary particles having an average primary particle diameter of 0.003 μm or more and 0.04 μm or less, and an average secondary particle diameter of 0.01 μm or more and 0.7 μm or less; and wherein the adhesive of the ink-fixing layer mainly comprises a polyvinyl alcohol.

9. A glossy ink-jet recording sheet according claim 3, wherein the pigment of the ink-fixing layer is at least one selected from the group consisting of a silica, an aluminosilicate and an alumina, wherein the silica, the aluminosilicate, and the alumina are secondary particles having an average primary particle diameter of 0.003 μm or more and 0.04 μm or less, and an average secondary particle diameter of 0.01 μm or more and 0.7 μm or less;
and wherein the adhesive of the ink-fixing layer mainly comprises a polyvinyl alcohol.

10. A glossy ink-jet recording sheet according to claim 8, wherein the ink-fixing layer further comprises a compound having a cross-linkability with the polyvinyl alcohol.

11. A glossy ink-jet recording sheet according to claim 9, wherein the ink-fixing layer further comprises a compound having a cross-linkability with the polyvinyl alcohol.

12. A glossy ink-jet recording sheet according to any one of claims 1-11, wherein the paper support comprises a chlorine-free pulp.
